(19) United States
(12) Patent Application Publication
(10) Pub. No.: US 2007/0295066 A1
(43) Pub. Date: Dec. 27, 2007

(54) AUTOMATIC, CONTACT-FREE BEARING CLEARANCE MEASUREMENT SYSTEM

(75) Inventor: Phil Livengood, Caldwell, TX (US)

Correspondence Address: GREENBERG TRAURIG, LLP, 1200 SEVENTEENTH STREET, SUITE 2400, DENVER, CO, 80202, US

(73) Assignee: DCP Midstream, LLC, Denver, CO (US)

(21) Appl. No.: 11/734,672

(22) Filed: Apr. 12, 2007

Related U.S. Application Data
(60) Provisional application No. 60/805,819, filed on Jun. 26, 2006.

(51) Int. Cl. G01M 19/00

(52) U.S. Cl. 73/118.1

(57) ABSTRACT

The present disclosure describes systems and methods for measuring bearing clearances in an internal combustion engine such as a reciprocating engine. The system uses a non-contacting measuring device to measure the movement of parts within a cylinder or cylinders of an engine as a vacuum is applied to the cylinder(s). As the pressure changes within the cylinder(s) the movement of the parts is recorded and then analyzed to identify the clearances of different bearings and compare the measured clearances to tolerances appropriate for the engine. Distance measurements may be taken from multiple points within the cylinder to generate a more accurate measurement of the displacement of the parts. The non-contacting measuring device reduces wear and damage to the piston surface from which the measurements are taken and also is more precise than a physical contact system based on a micrometer and plunger.

### RELATED APPLICATIONS

The application claims the benefit of U.S. Provisional Application No. 60/805,819, filed Jun. 26, 2006, the complete disclosures of which are incorporated herein by reference for all purposes.

### BACKGROUND

Over time, the bearings and other components of an internal combustion engine will wear down and ultimately fail. One method of maintaining a fleet of engines efficiently includes periodically monitoring the wear of bearings by measuring the various bearing clearances. Accurate measurement of wear allows engines to be pulled for maintenance at the most appropriate time, before the engine fails but not any earlier than absolutely necessary. The measuring of piston wrist pin clearance, connecting rod big end clearance, and the degree of sealing by valves, gaskets and rings in an engine cylinder can be difficult and time consuming. A need exists for a device, which simplifies such procedures.

### SUMMARY

The present disclosure describes systems and methods for measuring bearing clearances in an internal combustion engine such as a reciprocating engine. The system uses a non-contacting measuring device to measure the movement of parts within a cylinder or cylinders of an engine as a vacuum is applied to the cylinder(s). As the pressure changes within the cylinder(s) the movement of the parts is recorded and then analyzed to identify the clearances of different bearings and compare the measured clearances to tolerances appropriate for the engine. Distance measurements may be taken from multiple points within the cylinder to generate a more accurate measurement of the displacement of the parts. The non-contacting measuring device reduces wear and damage to the piston surface from which the measurements are taken and also is more precise than a physical contact system based on a micrometer and plunger.

One aspect of the disclosure is a measurement system for measuring bearing clearances in an engine with contacting measured surfaces within the engine. The system includes a probe comprising a probe body adapted to be inserted into an access port of a combustion chamber of an internal combustion engine. The system also has a measuring device connected to the probe body that measures a distance between the measuring device and a surface of a piston in the cylinder when the probe is inserted into the access port. There is a passage through the probe body and a pressure control component connected with the passage that changes the pressure in the combustion chamber when the probe is inserted into the access port. A control system is also provided that controls the operation of the pressure control component, thereby controlling the pressure in the combustion chamber, and that simultaneously receives measurements and stores data from the measuring device as the pressure in the combustion chamber changes.

The disclosure also describes a method of measuring bearing wear in a piston assembly of an engine, in which the piston assembly includes a piston and a piston rod. The method includes removing a spark plug from a spark plug port of a cylinder the engine containing the piston assembly and inserting a probe having a measurement device in the spark plug port. The probe forms a pressure seal with the spark plug port allowing the combustion chamber to be pressurized. The method further includes measuring, with the measuring device, a set of first distances from the probe to at least two different locations on the piston in the cylinder and, from these measurements calculating a first representative height of the piston in the cylinder. The method then changes the pressure in the cylinder, thereby moving the piston. After changing the pressure, the measuring device is used to measure a set of second distances from the probe to at least two different locations on the piston in the cylinder, wherein the second distances are different than the first distances as a result of the moving of the piston. A second representative height of the piston in the cylinder is calculated based on the second distances. The method then calculates a wrist pin bearing clearance based on the difference between the first and second representative heights. The method further includes repeating the pressure changing step, which causes the piston rod and piston to move, and the measurement calculating steps are repeated to determine a bearing clearance for the big rod end bearing.

The disclosure also describes yet another method for determining the wear of an engine. The method includes inserting an electronic distance measuring device into a cylinder in the engine, such as through an access port or a spark plug port, and then continuously changing the pressure within the combustion chamber (e.g., drawing an ever increasing vacuum) over a period of time, thereby causing a piston in the cylinder to move. The method further includes measuring, at different times within the period of time while the pressure is continuously changing, the displacement of the piston in the cylinder caused by the changing of the pressure as a function of time or pressure—but in any case taking multiple or continuous readings as the pressure is changed so that the discrete movements of the piston and piston assembly may be observed in the measurement data. The method then calculates, based on the measurements taken during the pressure changing, an amount of movement in the wrist pin bearing and the big rod end bearing. The electronic distance measuring device measures the displacement without making physical contact with the piston (e.g., through the use of light, sound or distance detection technologies) and without interrupting the changing of the pressure.

These and various other features as well as advantages will be apparent from a reading of the following detailed description and a review of the associated drawings. Additional features are set forth in the description which follows, and in part will be apparent from the description, or may be learned by practice of the described embodiments. The benefits and features will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of embodiments described herein and are not meant to limit the scope of the disclosed systems and methods in any manner, which scope shall be based on the claims appended hereto.

FIG. 1 is an illustration of an embodiment of a method for measuring bearing wear in an engine.

FIG. 2 is an illustration of an embodiment of the bearing clearance measurement device.

FIG. 3 is an illustration of an embodiment of the probe of a bearing clearance measurement device.

### DETAILED DESCRIPTION

An embodiment of the present disclosure is a system for measuring bearing clearances in an internal combustion engine such as a reciprocating engine. The system uses a non-contacting measuring device to measure the movement of parts within an engine as a vacuum is applied to those parts. The non-contacting measuring device reduces wear and damage to the piston surface from which the measurements are taken and also is more precise than a physical contact system based on a micrometer and plunger.

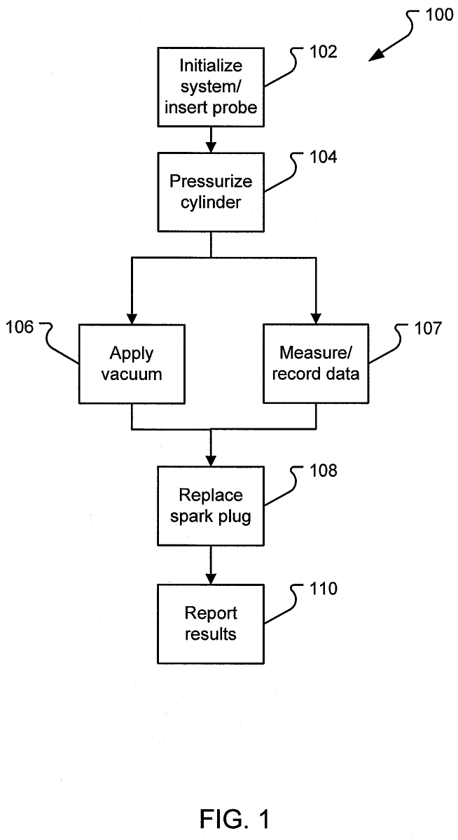

FIG. 1 illustrates an embodiment of a method of measuring bearing wear in an engine. The embodiment is described in terms of an internal combustion engine in which the crankshaft is lower than the cylinders. For this type of engine, when at rest the force of gravity drives the pistons and piston rods into the crankshaft.

In the embodiment of the method 100 shown, the system is initialized for taking a measurement, which includes inserting a probe in the cylinder of the engine in an initialize system and insert probe operation 102. As part of the initialize system and insert probe operation 102, information may be entered into the control electronics by the operator, such as selections of engine type, engine location, engine identification number, piston identification number, client, and any other information that may be useful for analyzing, recording and tracking the measurement data after the measurements have been taken.

In an embodiment, the insert probe operation may include removing a spark plug from the cylinder and inserting the probe in the spark plug port. In an alternative embodiment a different port may be used, such as for example a port provided specifically for that purpose. In an embodiment of the method 100, the probe may be a part of the engine that is inserted when the engine in manufactured.

The initialize system and insert probe operation 102 may optionally include orienting the piston rod in the cylinder to be measured to a preferred or known alignment. For example, the crankshaft may be manually rotated until the piston is at the highest or lowest point of its stroke. The may be done prior to the insertion of the probe or after. Furthermore, a pressure sensor or the distance measuring device of the probe may be utilized to determine or confirm that the piston is in the proper orientation.

The initialize system and insert probe operation 102 may also include spraying a mist of oil into the combustion chamber. This assists in creating a good seal between the piston and the cylinder walls so that the later operations involving pressure changes are more effective. A nozzle may be provided in the probe and attached to an oil source for this purpose, in which case the oil mist dispensing may be automatically controlled by the control system. Alternatively, the mist may be manually applied by the technician prior to inserting the probe or via the nozzle on the probe after the probe is inserted.

The initialize system and insert probe operation 102 may also include swiveling the measuring device to point at or in the general direction of the piston and may also include calibrating the measuring device to ensure an accurate measurement. In an alternative embodiment, a multi-directional distance sensor may be used that does not need to be specifically aligned. Such a sensor may obtain enough information from sufficient different locations within the cylinder for the control system to automatically determine the location of the piston regardless of the orientation of the sensor upon insertion.

After the system is prepared for the measurement, the cylinder is pressured in a pressurize cylinder operation 104. In an embodiment, pressure is provided from an external source, such as a shop compressor (typically referred to as shop air) used to operate pneumatic equipment. The pressure is applied through the probe, which is attached to the pressure and vacuum source(s). The pressure is applied for a period of time sufficient to displace oil from the bearings in the engine's piston assembly (i.e., the wrist pin bearing and the big rod end bearing). This allows the bearing clearance to be more accurately measured in later operations. In an embodiment, the pressure in the combustion chamber is increased to about a pressure of 125 pounds per square inch gauge (psig) for 15 seconds.

The pressurize cylinder operation 104 may also be used to check the piston rings and confirm that the proper seal is formed between the piston and the cylinder walls. Such information may be obtained from a pressure sensor optionally provided in the probe and relayed back to a control system controlling the operation of the measurement system. Such information may be stored so that it is associated in a database with the engine and cylinder from which the measurements were taken. If a desired level of pressure can not be maintained, a mist of oil may be automatically or manually applied in response.

After the pressurize cylinder operation 104, an apply vacuum operation 106 is performed while simultaneously taking measurements in a measurement operation 107. In the apply vacuum operation 106, the pressure is released or otherwise removed and the combustion chamber is evacuated through the probe. As the apply vacuum operation 106 is being performed, the measurement operation 107 monitors the displacement (i.e., the movement of the piston within the cylinder as determined by repeatedly measuring the distance between the distance measuring device and the piston as the vacuum is applied) of the piston in real time.

In an embodiment, an ultimate vacuum of about −28 inches of mercury is drawn on the combustion chamber which is most cases is sufficient to overcome the force of gravity on the piston and piston assembly. The vacuum drawn may be adjusted based on the anticipated weight of the piston and rod assembly in order to compensate for heavier or lighter assemblies.

As the vacuum is applied, at some point the pressure differential between the crankshaft chamber and the combustion chamber will overcome the downward force of gravity and force the piston to rise in the cylinder. The amount the piston rises (i.e. the change in distance) is a function of the bearing clearance of the piston wrist pin. A piston with a worn wrist pin bearing will rise more than a piston with a new bearing. From the measurements of the initial piston height and the height after the raising of the piston caused by applying the vacuum, a bearing clearance may be determined. In an embodiment the measurements and calculations are made and recorded automatically by the control system.

After the piston has been raised, applying a further vacuum will at some point cause the pressure differential between the crankshaft chamber and the combustion chamber to overcome the downward force of gravity on the piston and piston rod assembly and force the piston rod to rise in the cylinder, causing the piston to rise the same amount as well. The amount the piston rises (i.e., the change in distance or displacement) the second time is a function of the bearing clearance of the piston rod. A piston rod with a worn crankshaft bearing will rise more than a rod with a new bearing. From the measurements of the previous piston height and the height after the raising of the piston rod caused by applying the vacuum, a rod bearing clearance may be determined. In an embodiment the measurements and calculations are made and recorded automatically by the control system.

In an embodiment, the control system continuously increases the vacuum at a constant rate. The rate is selected so that, as the height of the piston changes, the measurement device can obtain an accurate reading before the piston is anticipated to change again. Note that even though the control system is attempting to adjust the combustion chamber's pressure at a continuous rate, the actual pressure observed will not be continuously increasing as the movement of the piston will change the volume of the combustion chamber during the operation 106.

The rate at which the pressure is changed by the control system may be adjusted for different engine types in order to compensate for heavier or lighter piston and rod assemblies. This will avoid such problems as having the pressure change so quickly that the system can not distinguish a piston height reading between the movement of the piston and the subsequent movement of the piston rod. As such, part of the initial set up may include the operator selecting an engine type from a list of types so that such things as absolute vacuum and pressure change rate may be automatically selected by the control system.

Because the control system can automatically and precisely control the pressure change and monitor the piston height simultaneously, correlations may be made to the amount of piston wear, the ability of the combustion chamber to hold a vacuum, and possible damage to the piston or piston rod that may change their respective weights and thus be detectable from the pressure differential needed to cause their movement.

The measurement operation 107 may include recording such data as height measurements of the face of the piston, measurement times and pressures throughout the process. The ability to take and store these measurements is limited only by the memory capacity, electronics and sensors selected for the system. Thus, very high speed and precise sensors could be used in order to very quickly perform the measurement operations. Alternatively, less expensive components could be used which may necessitate a slower rate of pressure change so that each of the two expected piston displacements can be identified from the data.

In addition, the measurement operation 107 may automatically record height data during a test as a function of time or pressure, thereby allowing graphs of displacement versus time or versus pressure to be generated automatically. From this raw data, the bearing clearances may be automatically and/or manually determined. Alternatively, the control system may be designed to detect the two expected displacements and calculate and record only the bearing clearances.

After the measurements have been taken, a replace spark plug operation 108 may be performed to return the cylinder to operational status. The measurements and data may be used to determine the relative bearing wear of the various parts of the engine and decisions made as to whether to pull the engine for maintenance or keep it in service until the next testing. Given that the control system may be computer system with access to the engine's operating specifications as well as testing data developed from other engines, the system may be able to diagnose the engine in real time and provide immediate feedback to the technician.

A condition analysis may be performed and a list of recommended actions could be automatically provided upon completion of the test in a report results operation 110. If the engine type is known, such results could be generated based on predetermined specifications for the engine and the engine's owner. For example, in an embodiment, the system may be provided with a set of tolerances for the different bearings of a particular engine type, such as a range of tolerances for proper operation, a second range for worn bearings but bearing that do not need immediate replacement, and a third range for bearings or assemblies so worn or damaged that immediate service is necessary. Such specifications may be provided by the engine manufacturer, the engine owner or both. The control system may automatically evaluate the raw data on a piston by piston basis or on an engine by engine basis and then generate a report identifying which range a particular piston is and provide a recommendation, such as “no service required,” “service during next regularly scheduled maintenance,” or “service immediately.”

The specific condition analysis and list of recommended actions provided in the report results operation 10 discussed above are illustrative only and provided only as an example of how the system may analyze the raw data and generate results. More, less or different analyses and recommendations may be used for different engine types (so that different engines may be distinguished), different engine locations (allowing different maintenance thresholds for hot, wet climates, for example) and different engine owners (thus allowing the technician to service multiple clients with the same equipment by simply selecting the client in the initiation of the system). The analysis thresholds, ranges and other data may be pre-determined and entered into the system by the operator in order to comply with the maintenance protocols for the engine or engine's owner.

In addition, the report results operation 110 may include reporting some or all of the data and results to a remote computer for further analysis. The system may automatically report the data and results electronically, such via a wireless connection, to the remote computer or the operator may download the results manually upon completion of the test. Such results when gathered for multiple engines at multiple sites allow for the wear data to be monitored, analyzed and used for different purposes than simply determining when to service the engine. The combined data may be used to evaluate the relative maintenance effects of using different engine components (such as for comparing different bearings from different manufacturers and comparing different lubricating oils) and different operating conditions (such as environmental differences and differences in engine operating conditions, e.g., rpm, load, fuel additives and fuel mixture).

The report results operation may be performed automatically upon completion of the measurement or may, in part or in whole, be performed in response to commands by the operator. For example, the control system may display or otherwise provide the test results to the technician after completion of a measurement cycle, such as on a display provided on the system. If the technician believes the quality of the measurement is poor (for example because the pressure data indicate that a sufficient vacuum was not achieved or because the raw data does not show an expected displacement profile), the test may easily be re-run by the technician by simply requesting the control system to execute another test, causing the control system perform the pressurize operation 104, apply vacuum operation 106 and the measurement operation 107 again. This may be repeated until the technician is satisfied by the results. In this case, the results of each of the tests may be stored for future evaluation.

In an embodiment the pressurize operation 104 and the apply vacuum operation 106 are controlled by the control system automatically and without intervention by the measuring technician. The technician may only need to perform the initialize system and insert probe operation 102, the rest of the operations being performed by the control system automatically, possibly in response to a technician issuing a start command.

In an embodiment, the measurements and pressure changes are performed as part of a continuous operation performed at a speed dictated by the ability of the control electronics to take accurate measurements. This allows for a faster testing time than systems that require a simultaneous user control of vacuum and manual logging of data read from a mechanical display.

It should be noted that an alternative embodiment of the method shown in FIG. 1 is used for engines or machines in which, under the rest condition, the force of gravity pulls the bearings to be measured apart. For example, in engine designs where the crankshaft is above the cylinder heads, when at rest gravity will act to pull the piston away from the crankshaft. In this alternative configuration, a different embodiment of the method of FIG. 1 is used in which the order of the pressurization operation 104 and the vacuum application operation 106 are reversed and the data is recorded during the pressurization operation 104.

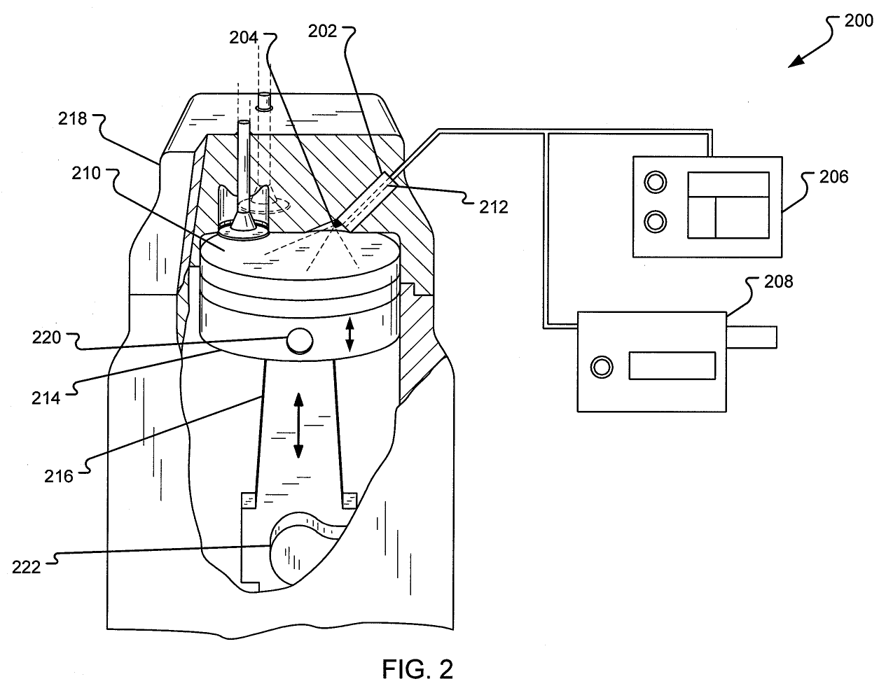

FIG. 2 illustrates a cylinder head and piston of an engine with an embodiment of the bearing clearance measurement system installed. A probe 202 is inserted into a cylinder head 218 into a combustion chamber above a piston 214 and at some angle to the piston surface 210. The piston 214 is attached by a wrist pin bearing 220 to a piston rod 216 in a conventional fashion. In addition, the piston rod 216 is attached to a crankshaft 222 by a big rod end bearing (not shown). The bearing clearance measurement system includes a probe 202 including a distance measuring device 204, a control system 206, and a pressure/vacuum source 208 (referred to as the compressor component 208) that may be driven by shop air as shown.

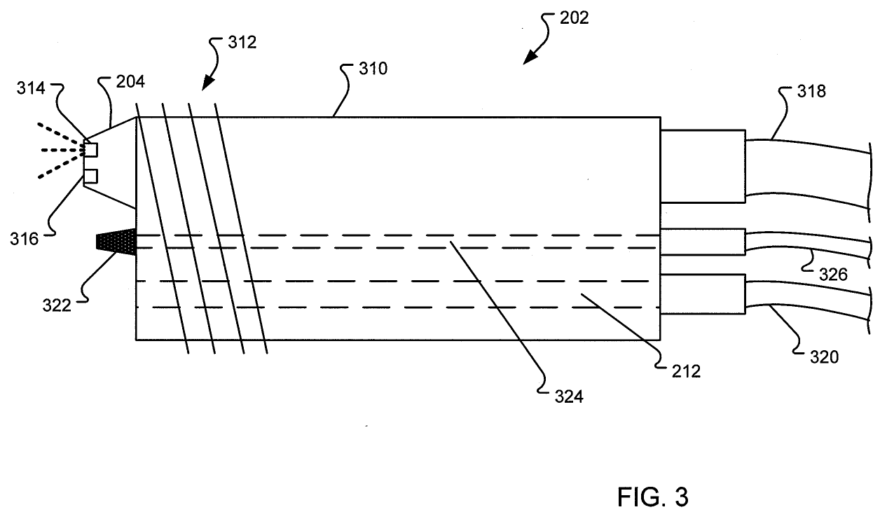

In an embodiment, the probe 202, illustrated generally but in greater detail in FIG. 3, includes a probe body 310 adapted to fit into the spark plug port in the cylinder head of an engine and seal. For example, many spark plugs use threads to engage and remove from the spark plug port and the body 310 may be provided with a similar set of threads 312. For engines with different types of spark plug ports or for probes designed to use different cylinder access ports, the engagement mechanism can be varied as needed. Thus, the shape and size of the body 310 and threads 312 thereon are dictated by the type of engine to be tested and access port to be used.

In an embodiment, the body 310 itself may be disengaged from the measuring device 204 and the measuring device 204 transferred to another probe body 310 adapted to a different engine type. This allows the same measuring device 204 to be used for different engines by selecting the appropriate probe body 310 for the engine and inserting the measuring device and hose or other connection through which the pressure is adjusted. In an alternative embodiment, each different probe body 310 may be provided with its own measuring device 204.

In the embodiment, the probe 202 includes a contact-less distance measuring device 204. In the embodiment shown, the measuring device 204 utilizes a combined laser or other light source 314 and a light detector 316 tuned to the light source's wavelength or otherwise designed to operate with the light source 314. Light is emitted by the light source 314 and the reflected light is detected by the light detector 316. From the properties of the light detected, the distance to the surface 210 reflecting the light can be determined. The measuring device 204 may be fixed to the body 310 of the probe or may be provided with a swivel (not shown) in order to direct the measuring device at the piston surface 210.

Although a light-based measuring device 204 is illustrated, any distance measuring device suitable for use in an explosive and pressurized environment may be used. For example, sonic devices and devices operating in various non-visible light wavelengths may be used. Use of light and laser light to determine a distance to a surface is well known in the art. Such measuring devices are commonly available and need not be described in greater detail herein. In addition, other contact-less measuring devices may be adapted for use in the probe described herein. For example, in an alternative embodiment an ultrasound distance measuring device is used that transmits one or more narrow pulses or beams of sound waves that bounce off the piston surface and return to the sound receiver. The signal produced by the receiver is then analyzed to determine the distance to the surface. Other technologies including those based on sound waves, Doppler laser, microwaves, radar waves or other types of emissions may be used instead of or in addition to coherent laser light in order to obtain an accurate measurement.

Depending on the technology and embodiment used, the data generated by the measuring device 204 may need to be further analyzed to determine the distance or height of the surface 210 of the piston. In an alternative embodiment, the output of the measuring device 204 may be the calculated distance and may not need any further processing. If additional processing is needed, such processing may be performed by the control system 206 or by a pre-processing module (not shown) associated with the measuring device 204 but located outside of the probe body 310.

In the embodiment shown, a multiple point measurement is made. This may be done using multiple lasers/light sources or by redirecting a single laser to point at different locations and monitoring the reflection from the different locations. Alternatively, the measuring device 204 may emit light (or other sensing signals) in multiple or all (such as in the case of non-coherent light) directions at once in order to get readings from many different locations, which readings are then analyzed to determined an average distance or even define the location of the plane of the surface 210 being measured.

The measurement may also be based on multiple readings. For example, an average of multiple readings of the same location may be used. As another example, measurements from three (or more) different locations on the surface of the piston may be correlated to determine the location and orientation of a planar surface (defined by the three points) relative to the location of the probe. This further allows the relative angle of the planar surface to be monitored as the piston moves. Note that the planar surface may correspond to the actual piston surface 210, or may only be used as a representative measure of the location and orientation of the piston if the piston surface 210 is not flat.

The control system 206 controls the operation of the measuring device 204 and the compressor component 208 and stores the data generated by the measuring device 204. The control system 206 both monitors and controls the pressure changes within the combustion chamber. The control system 206 may be provided with a start button or some other switch or user interface for starting the measurement. In an embodiment, the control system 206 may also be provided with various pressure gauges and air flow gauges for the benefit of the technician. The control system 206 may include a data storage device such as a disc drive for storing data. The control system 206 may also include a network connection of some kind (e.g., an Ethernet card, a modem, etc.) for connecting and transmitting data to a remote location for analysis. The control system may include an electronic display. The electronic display may further be touch sensitive and serve as the user interface with the technician.

For example, in an embodiment the control system 206 includes a laptop computer provided with software for controlling the operation of the compressor component 208 and the measuring device 204. The measuring device 204 and compressor component 208 are electronically coupled to the laptop, such via cables with the appropriate connectors or wirelessly, so that control signals, data and power, as necessary, may be transferred between the devices. In an embodiment, the measuring device 204 connects to the laptop via a cable 318 with USB connection, through which power and data signals are transferred.

The probe 202 illustrated also includes one or more passages 212 through the body 310 with which the pressure changes in the cylinder head are created. In the embodiment shown, a single passage 212 through the probe is provided through which air may be supplied to increase pressure or air may be removed to induce a vacuum. The passage is connected (such as by a flexible pressure hose 320) to a compressor component that is controlled by the control system 206. In an alternative embodiment, the measuring device 204 is surrounded by a passage in the form of an annulus so that the measuring device is located at the center of the probe 202. The exact configuration of the passage 212 and the measuring device 204 of the probe 202 may be adapted for specific needs and as is convenient to the manufacturer as long as the probe 202 can operate as described herein.

In an embodiment, the compressor component 208 utilizes shop air to either increase the pressure in the cylinder or draw a vacuum on the cylinder in response to commands from the control system 206. In this embodiment, the compressor component 208 may include an electronically controlled pressure regulator attached to a shop air system. Depending on the commands received by the regulator, shop air is used to either generate a pressure within or draw a vacuum on the combustion chamber through the passage 212 in the probe 202. Alternative types of equipment may be also be used for the compressor component 208 as long as enough vacuum can be drawn to lift the piston and piston rod.

In an embodiment, the compressor component 208 is capable of placing a pressure of up to 125 psig on the combustion chamber and evacuate to the chamber to achieve a vacuum of about −28 inches of mercury relative to the ambient pressure outside the chamber. Depending on the type of engine to be analyzed, the compressor component may be adapted to generate higher pressures and draw a greater vacuum as necessary to cause the piston and/or piston assembly to displace given the piston's and assembly's mass and the configuration of the engine.

The probe 202 may also include an oil mist dispenser as shown. The dispenser may include a nozzle 322 on the end of the probe 202 connected to a second passage 324 through the probe body 310 that is connected (such as by flexible tubing 326) to a source of oil (not shown). The oil source (not shown) may be a simple manually operated oil reservoir capable of pushing oil into the probe at pressure. Alternatively, the oil reservoir may be controlled by the control system 206 allowing the control system to automatically inject mists of oil as necessary.

The use of a triangulating, non-contacting distance measurement system has many benefits. First, there is no contact with the piston, reducing the chance of potential damage to the piston surface 210 caused by the testing. Second, suitable sonic or light-based measurement devices 204 are more robust than mechanical devices as they tend to have no moving parts and are less prone to damage than, for example, a micrometer based measurement device. Third, by taking measurements from multiple locations on the piston surface 210 a more accurate measure of the height of the piston 214 may determined—essentially removing any error that may be introduced by changes in angle of the piston 214 as it is raised in the cylinder during measurement. These measurements also correct for any difference in angle between the probe 202 and the piston surface 210, as the height of the plane of the piston surface 210 may be determined automatically from the measurements regardless of the angle from which the probe 202 is taking the measurements.

The automated measurement system reduces the risk of technician induced error and allows for more precise measurements to be taken. The additional precision and ability to simultaneously measure displacement and pressure make the system more useful and increase the technician's ability to diagnose other problems with the engine from the data.

The automated system further allows for much quicker testing than a manual system. In addition, the pressure may be precisely controlled so the exact pressure needed to displace the piston 214 and piston rod 216 may be determined with great accuracy.

The system described herein could be adapted for use in any cylinder with a piston 214. Those applications include any engine from a large marine propulsion engine to a gas compressor engine, to an automotive engine or smaller.

Because of the environment in which the system is expected to be used, the various components of the system may be “explosion-proof” in that they are designed and manufactured to operate in a flammable atmosphere without providing an ignition source.

It will be clear that the present invention is well adapted to attain the ends and advantages mentioned as well as those inherent therein. Those skilled in the art will recognize that the methods and systems of the present invention within this specification may be implemented in many manners and as such is not to be limited by the foregoing exemplified embodiments and examples. In other words, functional elements being performed by a single or multiple components, in various combinations of hardware and software, and individual functions can be distributed among software applications at either the client or server level. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope of the present invention. For example, multiple probes may used to simultaneously test each cylinder in an engine simultaneously. This would allow a further testing to determine the crankshaft bearing clearances by raising the crankshaft in response to a vacuum being pulled on all cylinders at once.

Numerous other changes may be made which will readily suggest themselves to those skilled in the art and which are encompassed in the spirit of the invention disclosed and as defined in the appended claims.

What is claimed is:

1. A measurement system comprising;
a probe comprising a probe body adapted to be inserted into an access port of a combustion chamber of an internal combustion engine;
a measuring device connected to the probe body that measures a distance between the measuring device and a surface of a piston in the cylinder when the probe is inserted into the access port;
a passage through the probe body;
a pressure control component connected with the passage that changes the pressure in the combustion chamber when the probe is inserted into the access port; and
a control system that controls the operation of the pressure control component, thereby controlling the pressure in the combustion chamber, and that simultaneously receives measurements from the measuring device as the pressure in the combustion chamber changes.

2. The measurement system of claim 1 wherein the measuring device measures the distance between the measuring device and the surface of the piston via emitting light and detecting a reflection of the light from the surface.

3. The measurement system of claim 2 wherein the light emitted is a coherent light.

4. The measurement system of claim 1 wherein the measuring device measures the distance between the measuring device and the surface of the piston via emitting a sound and detecting an echo of the emitted sound.

5. The measurement system of claim 1 wherein the measuring device determines the distances from the probe to at least three different locations on the surface of the piston without physically contacting the surface.

6. The measurement system of claim 5 wherein the system calculates a planar location of the piston from the probe based on the measured distances to the at least three different locations.

7. The measuring device of claim 1 further comprising:
an oil injector incorporated into the probe body attached to an oil reservoir, the oil injector adapted to inject oil into the combustion chamber.

8. The measuring device of claim 1 wherein the control system records the measurements received from the measuring device as the pressure is changed, thereby recording changes in piston location indicative of a wrist pin bearing clearance and a big rod end bearing clearance.

9. The measuring device of claim 1 wherein the control system analyzes the measurements received and presents results of the analysis to an operator, the results identifying the wrist pin bearing clearance and the big rod end bearing clearance.

10. The measuring device of claim 9 wherein the analysis includes making a service recommendation based on a comparison of the measurements with a predetermined threshold associated with the wrist pin bearing clearance and the big rod end bearing clearance for the internal combustion engine.

11. A method of measuring bearing wear in a piston assembly of an engine, the piston assembly including a piston and a piston rod, the method comprising:
removing a spark plug from a spark plug port of a cylinder the engine containing the piston assembly;
inserting a probe having a measurement device in the spark plug port;
measuring, with the measuring device, first distances from the probe to at least two different locations on the piston in the cylinder;
calculating a first representative height of the piston in the cylinder;
changing the pressure in the cylinder, thereby moving the piston;
after changing the pressure, measuring, with the measuring device, second distances from the probe to at least two different locations on the piston in the cylinder, wherein the second distances are different than the first distances as a result of the moving of the piston;
calculating a second representative height of the piston in the cylinder based on the second distances; and
calculating a wrist pin bearing clearance based on the difference between the first and second representative heights.

12. The method of claim 11 further comprising:
comparing the wrist pin bearing clearance to a predetermined wrist pin bearing specification for the engine; and
based on results of the comparing operation, generating a wrist pin bearing service recommendation.

13. The method of claim 11 further comprising:
pressurizing the cylinder prior to measuring the first distances.

14. The method of claim 11 further comprising:
after measuring the second distances, again changing the pressure in the cylinder, thereby moving the piston and the piston rod; and
after again changing the pressure, measuring, with the measuring device, third distances from the probe to at least two different locations on the piston in the cylinder, wherein the third distances are different than the first and second distances as a result of the moving of the piston and piston rod.

15. The method of claim 14 further comprising:
calculating a third representative height of the piston in the cylinder based on the third distances; and
calculating a big rod end bearing clearance based on the difference between the third and second representative heights.

16. The method of claim 15 further comprising:
comparing the big rod end bearing clearance to a predetermined big rod end bearing specification for the engine; and
based on results of the comparing operation, indicating a big rod end bearing service recommendation associated with the predetermined big rod end bearing specification for the engine.

17. A method for determining the wear of an engine comprising:
inserting an electronic distance measuring device into a cylinder in the engine;
continuously changing the pressure within the combustion chamber over a period of time, thereby causing a piston in the cylinder to move;
measuring, at different times within the period of time while the pressure is continuously changing, displacement of the piston in the cylinder caused by the changing of the pressure;
calculating, based on the measured displacement at different times within the period of time, an amount of movement in the wrist pin bearing; and
wherein the electronic distance measuring device measures the displacement without making physical contact with the piston and without interrupting the changing of the pressure.

18. The method of claim 17 further comprising:
calculating, based on the measured displacement at different times within the period of time, an amount of movement in the big rod end bearing.

19. The method of claim 17 wherein measuring displacement further comprises:
repeatedly measuring a distance between the piston and the electronic distance measuring device during the period of time; and
storing the measured distances.

20. The method of claim 17 wherein measuring displacement further comprises:
measuring, at different times during the period of time, a distance between a plurality of locations on the piston and the electronic distance measuring device; and
calculating a representative distance between the piston and the electronic distance measuring device for each of the different times.
